(19) United States
(12) Patent Application Publication
(10) Pub. No.: US 2025/0026323 A1
(43) Pub. Date: Jan. 23, 2025

(54) PEDAL DEVICE FOR VEHICLE

(71) Applicant: DENSO CORPORATION, Kariya-city (JP)

(72) Inventors: Atsushi NISHIMURA, Kariya-city (JP); Etsugo YANAGIDA, Kariya-city (JP); Yuki MATSUNAGA, Kariya-city (JP); Masashi ARAO, Kariya-city (JP)

(21) Appl. No.: 18/909,799

(22) Filed: Oct. 8, 2024

Related U.S. Application Data
(63) Continuation of application No. PCT/JP2023/016859, filed on Apr. 28, 2023.

(30) Foreign Application Priority Data
Apr. 29, 2022 (JP) 2022-075565

(51) Int. Cl. B60T 7/06; B60T 7/04

(52) U.S. Cl. CPC B60T 7/06; B60T 7/042

(57) ABSTRACT

A pedal device for a vehicle includes a pedal unit, a rubber member and a restricting member. The pedal unit is displaced by receiving a pedal operation from a driver of the vehicle. The rubber member is pressed by the pedal unit displaced in response to the pedal operation and generates a reaction force against a displacement of the pedal unit. The restricting member is configured to restrict the displacement of the pedal unit separately from the rubber member, when the rubber member generates the reaction force.

### CROSS REFERENCE TO RELATED APPLICATION

The present application is a continuation application of International Patent Application No. PCT/JP2023/016859 filed on Apr. 28, 2023, which designated the U.S. and claims the benefit of priority from Japanese Patent Application No. 2022-075565 filed on Apr. 29, 2022. The entire disclosures of all of the above applications are incorporated herein by reference.

### TECHNICAL FIELD

The present disclosure relates to a pedal device for a vehicle.

### BACKGROUND

Conventionally, a stroke simulator is provided to generate a reaction force against an operation of a brake pedal by compressing and deforming an elastic body due to movement of a piston. In such a stroke simulator, a rubber damper or the like that is pressed by the piston inside a housing is used as a member that generates a reaction force.

### SUMMARY

According to one aspect of the present disclosure, a pedal device for a vehicle includes a pedal unit, a rubber member, and a restricting member. The pedal unit is configured to be displaced in response to a pedal operation from a driver of the vehicle. The rubber member is configured to be pressed by the pedal unit displaced in response to the pedal operation and to generate a reaction force against a displacement of the pedal unit. In addition, the restricting member is configured to restrict the displacement of the pedal unit separately from the rubber member, when the rubber member generates the reaction force.

### BRIEF DESCRIPTION OF THE DRAWINGS

Objects, features, and advantages of the present disclosure will become more apparent from the following detailed description made with reference to the accompanying drawings, in which:

FIG. 1 is a front view of a pedal device in a first embodiment;

FIG. 2 is a view taken along an arrow II in FIG. 1;

FIG. 3 is a cross-sectional view taken along a line III-III in FIG. 2 in an initial position;

FIG. 4 is an enlarged perspective view of a rubber member and a restricting member;

FIG. 5 is a cross-sectional view taken along a line V-V in FIG. 2 when a pedal arm contacts the restricting member;

FIG. 6 is a cross-sectional view taken along a line VI-VI in FIG. 5 when the pedal arm contacts the restricting member;

FIG. 7 is a cross-sectional view taken along a line III-III in FIG. 2 at an initial position in a second embodiment;

FIG. 8 is a cross-sectional view taken along the line III-III in FIG. 2 when the pedal arm contacts the restricting member;

FIG. 9 is a cross-sectional view taken along a line IX-IX in FIG. 8;

FIG. 10 is a cross-sectional view taken along the line III-III in FIG. 2 at the initial position in a third embodiment;

FIG. 11 is a cross-sectional view taken along the line V-V in FIG. 2 when the pedal arm contacts the restricting member;

FIG. 12 is a cross-sectional view taken along a line XII-XII in FIG. 11;

FIG. 13 is an enlarged perspective view of a rubber member and a restricting member in a fourth embodiment;

FIG. 14 is a cross-sectional view taken along the line III-III in FIG. 2 at an initial position of a fifth embodiment; and

FIG. 15 is a cross-sectional view taken along the line III-III in FIG. 2 at an initial position of a sixth embodiment.

### DETAILED DESCRIPTION

A relevant art discloses a stroke simulator that generates a reaction force against an operation of a brake pedal by compressing and deforming an elastic body due to movement of a piston. In such a stroke simulator, a rubber damper or the like that is pressed by the piston inside a housing is used as a member that generates a reaction force.

According to the study of inventors, when an excessive load is applied to the rubber damper, because an escape area of the rubber damper is small, the rubber damper may get caught between the housing and the piston, and thereby there is a possibly of causing damage such as being cut, damaged or the like. Situation described above may occur not only in brake operations but also in general pedal operations in a vehicle.

It is an object of the present disclosure to reduce the possibility of damage to a rubber member that generates a reaction force in a pedal device.

According to one aspect of the present disclosure, because a restricting member is provided to restrict a displacement of a pedal unit separately from a rubber member, the restricting member can restrict the displacement of the pedal unit even when an excessive load is applied to the rubber member. Thus, the restricting member can be made to protect the rubber member. Therefore, the possibility of damage to the rubber member is reduced.

Hereinafter, an embodiment of the present disclosure will be described.

In the following embodiments, parts that are the same or equivalent to those described in the preceding embodiments are given the same reference numerals, and their explanations may be omitted. In the following embodiments, when only partial configuration element is described in one embodiment, remaining configuration element may adopt same configurations as that described in the preceding embodiments. The following embodiments may be partially combined with each other even if such a combination is not explicitly described as long as there is no disadvantage with respect to such a combination.

### First Embodiment

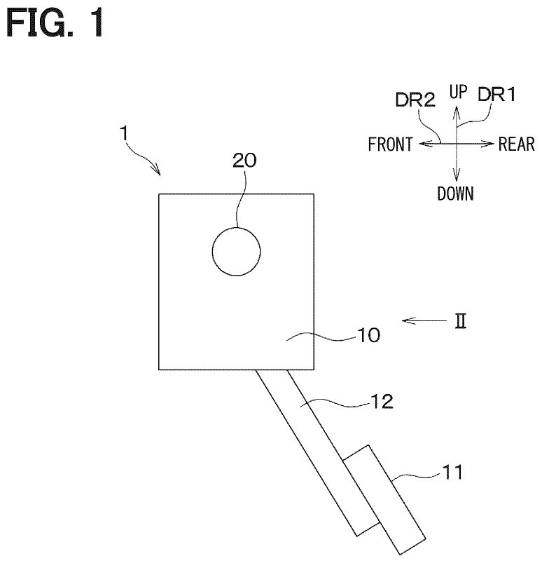

First, the first embodiment will be described in the following. FIGS. 1 to 6 show a pendant-type pedal device 1 for a vehicle according to the present embodiment. The pedal device 1 is mounted on a vehicle, and receives pedal operations (e.g., depressing operation and returning operation with a foot or the like) by a driver of the vehicle. Then, the pedal device 1 outputs an operation amount signal corresponding to the received pedal operation amount to a brake control circuit (not shown). A brake control circuit controls a brake actuator (for example, an electric pump that adjusts hydraulic pressure in a hydraulic brake circuit) (not shown) according to the operation amount signal. As described above, the pedal device 1 is a device for realizing brake-by-wire.

As shown in FIGS. 1 to 4, the pedal device 1 includes a housing 10, a pedal pad 11, a pedal arm 12, a rotating shaft 13, a reaction force generating mechanism 15, a rubber member 16, restricting members 17a and 17b, a sensor 20, and the like.

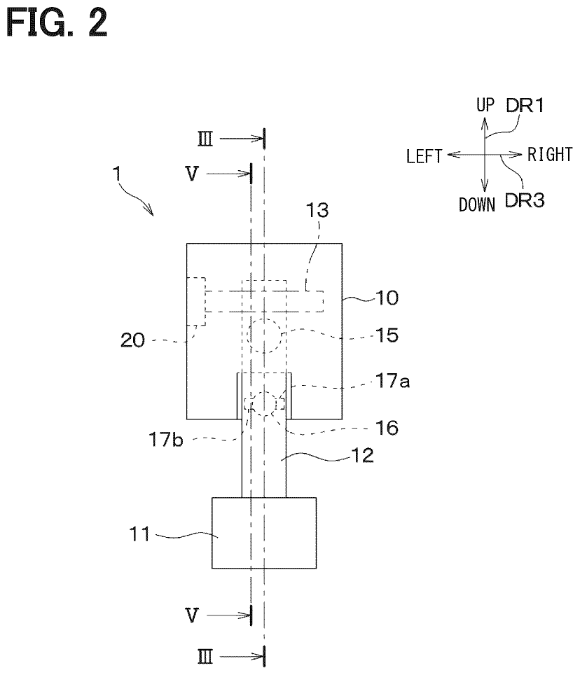

The housing 10 is a casing that holds and accommodates the pedal pad 11, the pedal arm 12, the rotating shaft 13, the reaction force generating mechanism 15, the rubber member 16, the restricting members 17a, 17b, the sensor 20, and the like. The pedal device 1 is installed in a vehicle by fixing the housing 10 to a dash panel or the like, which is a partition wall that separates the outside of the vehicle from the interior of the vehicle, using a fastening member such as a bolt (not shown). A vehicle vertical direction DR1 showing up and down, a vehicle longitudinal direction DR2 showing front and rear, and a vehicle width direction DR3 showing right and left when the pedal device 1 is installed in the vehicle are as shown in FIGS. 1 and 2. Further, a bearing portion (not shown) that rotatably supports the rotating shaft 13 is formed in the housing 10.

The pedal pad 11 is a plate-shaped member that receives a pedal operation by the driver of the vehicle. The pedal pad 11 is fixed to the pedal arm 12. The pedal arm 12 is made of a highly-rigid member such as resin, and is fixed to the pedal pad 11 at one end in the longitudinal direction, and is fixed to the rotating shaft 13 at the other end.

The rotating shaft 13 is a rod-shaped member extending along an axis CL, and is supported at both longitudinal ends by bearings (not shown) formed in the housing 10, so that the rotating shaft 13 is rotatable about the axis CL with respect to the housing 10. The axis CL extends generally along the vehicle width direction DR3. The bearing portion may be not formed integrally with the housing 10, but may be formed separately from the housing 10 and attached to the housing 10. Further, the rotating shaft 13 may be formed integrally with the pedal arm 12.

With such a structure, when the driver performs a pedal operation such as depressing operation, returning operation or the like for the pedal pad 11, the pedal pad 11, the pedal arm 12, and the rotating shaft 13 swing in one body about the axis CL according to the content of the pedal operation. The pedal pad 11, the pedal arm 12, and the rotating shaft 13 constitute a pedal unit that rotates together in response to a driver's operation. The pedal unit may be formed as an integral part as a whole, or the pedal pad 11, pedal arm 12, and rotation shaft 13 may be formed separately and then attached to each other.

The reaction force generating mechanism 15 is a mechanism that generates a force (that is, a reaction force) against the pedal operation on the pedal pad 11 when the pedal depressing operation is performed. As described above, since the pedal device 1 is used for brake-by-wire, the pedal pad 11 does not receive any reaction force from a master cylinder of a brake hydraulic pressure circuit. A reaction force that replaces the reaction force from the master cylinder is generated by the reaction force generating mechanism 15. The reaction force generating mechanism 15 has one end attached to a bottom wall of the housing 10 and an other end attached to the pedal arm 12, and is disposed at a position between the bottom wall of the housing 10 and the pedal arm 12, and generates a reaction force by being compressed. The reaction force generating mechanism 15 may be a metal elastic member (for example, a spring such as a coil spring), a rubber elastic member, or a fluid damper.

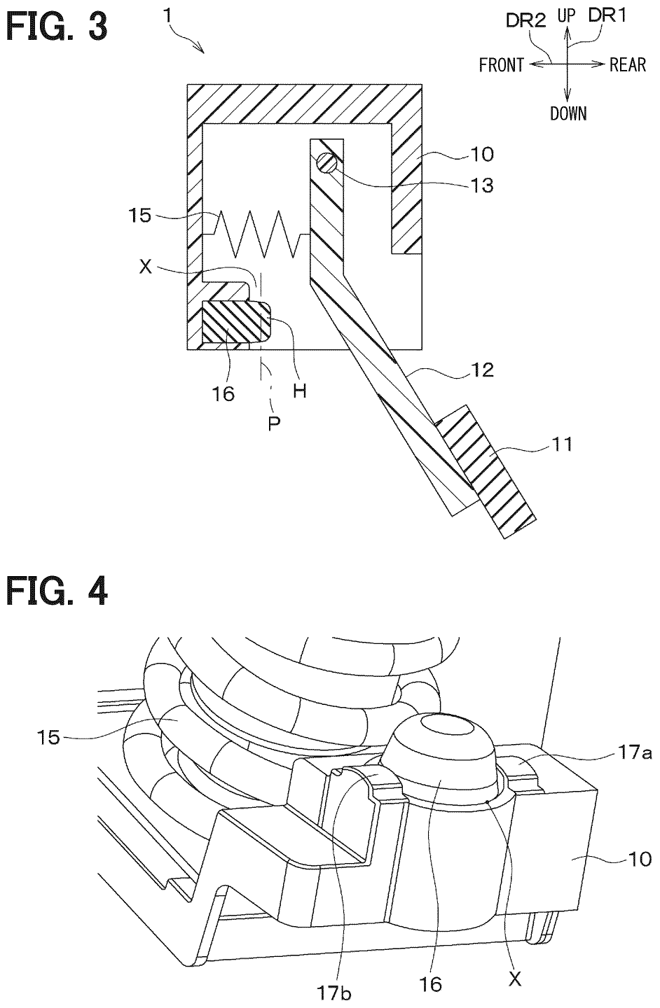

When the pedal pad 11 is not receiving any pedal operation, the pedal pad 11 is positioned at a predetermined initial position shown in FIG. 3. The reaction force generating mechanism 15 may bias the pedal arm 12 in a returning direction both of when (a) the pedal pad 11 is receiving the pedal operation and (b) when the pedal pad 11 is at the initial position without receiving the pedal operation. Further, the reaction force generating mechanism 15 may be connected to the housing 10 and the pedal arm 12 both of when (a) the pedal pad 11 is receiving the pedal operation and (b) when the pedal pad 11 is at the initial position without receiving the pedal operation.

The rubber member 16 is a member made of rubber, which restricts and stops the movement of the pedal unit by generating a reaction force against the displacement of the pedal unit under the depressing operation thereof. As shown in FIGS. 2 to 4, the rubber member 16 is arranged on one side of the reaction force generating mechanism 15 with reference to the pedal arm 12. Further, the rubber member 16 is arranged on an opposite side of the rotating shaft 13 with respect to the reaction force generating mechanism 15. As shown in FIGS. 3 and 4, the rubber member 16 is attached to the housing 10 by, for example, press-fitting, adhesion, or the like. An end of the rubber member 16 on a pedal arm 12 side is exposed to the pedal arm 12.

The restricting members 17a and 17b are members that restrict the displacement of the pedal unit separately from the reaction force generating mechanism 15 and the rubber member 16 when the reaction force generating mechanism 15 and the rubber member 16 are generating a reaction force against the pedal arm 12. The restricting members 17a and 17b are formed integrally with the housing 10.

The restricting member 17a is arranged on one side of the rubber member 16 in the vehicle width direction DR3, and the restricting member 17b is arranged on the other side of the rubber member 16 in the vehicle width direction DR3. That is, the restricting members 17a and 17b respectively surround a side surface of the rubber member 16 (that is, a surface surrounding a contacting surface of the rubber member that contacts the pedal arm 12) only from one side of the rubber member 16, not from the entire circumference of the side surface of the rubber member 16.

End portions of the restricting members 17a, 17b on a pedal arm 12 side are recessed with respect an end portion of the rubber member 16 on the pedal arm 12 side. That is, the rubber member 16 protrudes more toward the pedal arm 12 than the restricting members 17a and 17b. The restricting members 17a and 17b have higher rigidity than the rubber member 16. Specifically, the restricting members 17a and 17b have a higher Young's modulus than the rubber member 16. For example, the restricting members 17a and 17b may be made of resin or made of metal.

The sensor 20 detects an amount of depression of the pedal pad 11, that is, the amount of displacement of the pedal unit, and outputs a detection result as a signal. The sensor 20 may be a sensor (a rotary encoder, a hall sensor, an inductive sensor, or the like) that detects a rotation angle of the rotating shaft 13, or may be a sensor that detects the displacement amount of the pedal unit using another method.

Hereinafter, the operation of the pedal device 1 having such a configuration will be explained. When the driver performs a pedal operation such as depressing operation, returning operation of the pedal pad 11 or the like, the rotating shaft 13 rotates about the axis CL as the pedal pad 11 displaces its position. Then, a signal corresponding to the rotation of the rotating shaft 13 is output from a sensor element 22b of the sensor 20. The output signal is input to a brake ECU (not shown), and the brake ECU controls the brake actuator to apply a braking force to the wheels of the vehicle according to a rotation position of the rotating shaft 13 based on the input signal.

When a pedal operation is performed on the pedal device 1, the reaction force generating mechanism 15 expands and contracts. Specifically, when the depressing operation for the pedal is performed, it contracts and generates a stronger reaction force, and when the returning operation for the pedal is performed, it expands and reduces the reaction force.

When a long stroke depressing operation is performed on the pedal pad 11, the pedal arm 12 comes into contact with the rubber member 16 while the pedal unit is displaced in a depressing direction by receiving the reaction force of the reaction force generating mechanism 15. When the pedal arm 12 comes into contact with the rubber member 16, the rubber member 16 generates an elastic force against the pedal arm 12 in the returning direction. This elastic force, that is, the reaction force, stops the movement of the pedal unit. At this time, when the force received by the pedal pad 11 due to the depressing operation is within a predetermined range, the pedal arm 12 does not come into contact with the restricting members 17a, 17b but is separated therefrom.

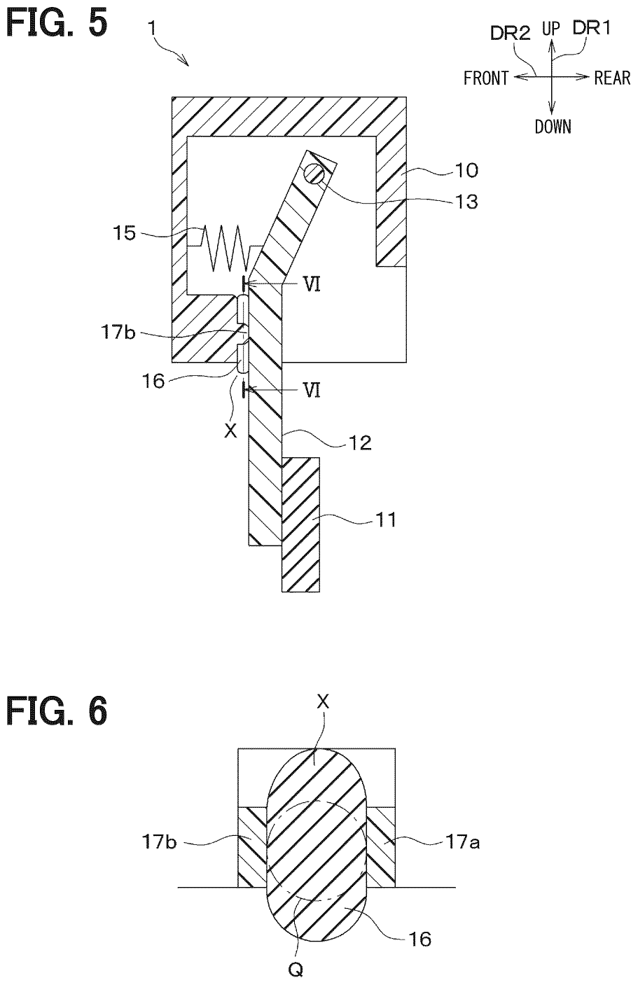

However, when the pedal arm 12 is depressed with a force exceeding the predetermined range, an excessive load is applied from the pedal arm 12 to the rubber member 16 after the pedal arm 12 contacts the rubber member 16. As a result, the rubber member 16 is pressed by the pedal arm 12 and deforms greatly, and as shown in FIG. 5, the pedal arm 12 moves until it comes into contact with the restricting members 17a and 17b.

When the pedal arm 12 comes into contact with the restricting members 17a and 17b, the movement of the pedal arm 12 stops. Therefore, the rubber member 16 will not be deformed any further. Therefore, the possibility of damage such as cutting or breaking the rubber member 16 is reduced.

At this time, when there is no place for the rubber member 16 to escape as it attempts to deform, the rubber member 16 will be pressed by the pedal arm 12 and flattened excessively, potentially damaging the rubber member 16. However, in the present embodiment, as shown in FIGS. 4, 5, and 6, there is a space where the rubber member 16 escapes, and the rubber member 16 is actually pressed by the pedal arm 12 and moves into such space. In such manner, the possibility of causing damage to the rubber member 16 can be reduced.

To explain in more details, an area occupied by the rubber member 16 when the pedal unit is in the initial position as shown in FIG. 3 is defined as an initial rubber area. A circular one-dot chain line Q in FIG. 6 indicates that the inside thereof is the initial rubber area. Further, the position where the pedal unit is restricted by the restricting members 17a and 17b as shown in FIG. 5 is defined as a restricted position. A one-dot chain line P in FIG. 3 indicates a position on a surface of the pedal arm 12 on a rubber member 16 side when the pedal unit is in the restricted position.

Further, an area where a trace area of the pedal unit when the pedal unit moves from the initial position to the restricted position overlaps the initial rubber area is defined as an interference area H. In FIG. 3, the initial rubber area on the right side of the one-dot chain line P is the interference area H.

Then, a gap obtained by excluding an area occupied by the pedal unit at the restricted position from a surrounding gap around the initial rubber area is defined as an escape area X. In the present embodiment, the escape area X between the restricting member 17a and the restricting member 17b is not closed, but is open to a space outside the pedal device 1. Therefore, a volume of the escape area X is much larger than a volume of the interference area H. When the volume of the escape area X is larger than the volume of the interference area H, there is a sufficient space for the rubber member 16 to deform and escape when it is strongly pressed by the pedal arm 12, thereby reducing a possibility of causing damage to the rubber member 16.

As explained above, the restricting members 17a and 17b restrict the displacement of the pedal unit separately from the rubber member 16 when the rubber member 16 is generating a reaction force. In such manner, by providing the restricting members 17a and 17b that restrict the displacement of the pedal unit separately from the rubber member 16, even when an excessive load is applied to the rubber member 16, the restricting members 17a and 17b restrict the displacement of the pedal unit. That is, the restricting members 17a and 17b protect the rubber member 16. Therefore, the possibility of causing damage to the rubber member 16 can be reduced.

(1) Also, the volume of the escape area X is larger than the volume of the interference area H. Thus, there is sufficient space for the rubber member 16 to deform and escape when it is strongly pressed by the pedal unit, thereby reducing the possibility of causing damage to the rubber member 16 can be reduced.

(2) Further, as shown in FIGS. 5 and 6, when the pedal unit is in the restricted position, the escape area X is a space open to the outside of the pedal device 1. With such a configuration, it is easy to ensure a sufficient space for the rubber member 16 to deform and escape when it is strongly pressed by the pedal unit.

(3) Further, the restricting members 17a and 17b are made of resin or metal. Therefore, the restricting members 17a and 17b can stop the pedal unit more strongly than the rubber member 16. Further, when the restricting members 17a and 17b are made of metal, they can have higher rigidity and strength than when made of resin. Further, when the restricting members 17a and 17b are made of resin, it is possible to reduce the collision noise generated when the pedal unit comes into contact with the pedal unit.

(4) Also, the restricting members 17a and 17b come into contact with the pedal arm 12 that presses the rubber member 16 among the three parts that constitute the pedal unit, i.e., the pedal pad 11, the pedal arm 12, and the rotating shaft 13, for restricting the displacement of the pedal unit. In such manner, the number of parts can be reduced because the part that presses the rubber member 16 and the member that contacts the restricting members 17a and 17b are configured as the same part.

(5) Further, the restricting members 17a and 17b come into contact with the pedal unit to restrict the displacement of the pedal unit. In such manner, it is possible to reduce a load transmission path from the pedal unit, which is a member that receives a pedaling force, to the restricting members 17a and 17b that restrict the pedal stroke. As a result, the number of parts that need to be strengthened to withstand strong pedaling can be reduced.

(6) Further, the restricting members 17a and 17b are formed integrally with the housing 10. With such a configuration, it is possible to reduce a load transmission path from the pedal unit that receives the pedaling force to a fixing point to the vehicle via the restricting members 17a and 17b that restrict the pedal stroke. As a result, the number of parts that need to be strengthened to withstand strong pedaling can be reduced.

### Second Embodiment

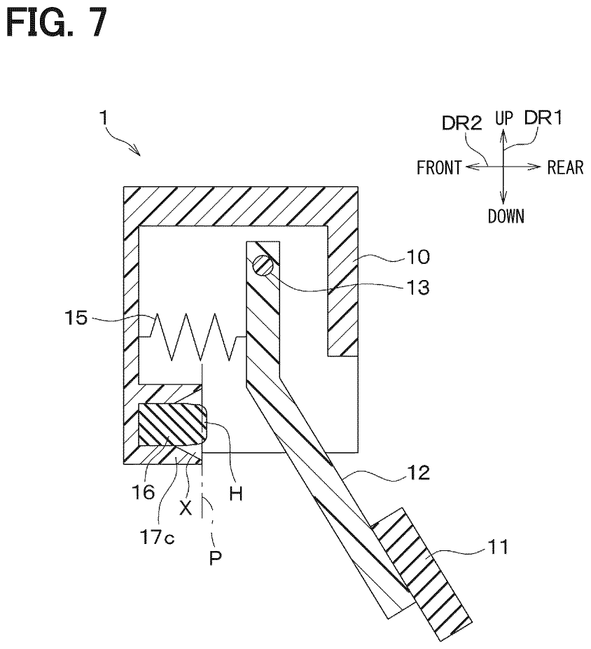

Next, the second embodiment will be described using FIGS. 7, 8, and 9. In the present embodiment, the restricting members 17a and 17b of the first embodiment are replaced with a restricting member 17c. The other configurations are the same as the first embodiment.

The restricting member 17c is a member that restricts displacement of the pedal unit separately from a reaction force generating mechanism 15 and a rubber member 16 when the reaction force generating mechanism 15 and the rubber member 16 are generating a reaction force. The restricting member 17c is formed integrally with a housing 10. The restricting member 17c is a member that annularly surrounds the rubber member 16 from an entire circumference of a side surface thereof.

An end of the restricting member 17c on a pedal arm 12 side is more recessed with respect to the pedal arm 12 than an end of the rubber member 16 on the pedal arm 12 side. That is, the rubber member 16 protrudes more toward the pedal arm 12 than the restricting member 17c. The restricting member 17c has higher rigidity than the rubber member 16. Specifically, the restricting member 17c has a higher Young's modulus than the rubber member 16. For example, the restricting member 17c may be made of resin or metal.

Hereinafter, the operation of the pedal device 1 having such a configuration will be explained. The operation when the force applied to a pedal pad 11 by the depressing operation of the driver is within a predetermined range is the same as in the first embodiment. At this time, the restricting member 17c is maintained in a state in which it does not come into contact with the pedal arm 12.

When the pedal pad 11 is depressed with a force exceeding the predetermined range, an excessive load is applied from the pedal arm 12 to the rubber member 16 after the pedal arm 12 contacts the rubber member 16. As a result, the rubber member 16 is pressed by the pedal arm 12 and deforms greatly, and as shown in FIG. 9, the pedal arm 12 moves until it comes into contact with the restricting member 17c.

When the pedal arm 12 comes into contact with the restricting member 17c, the movement of the pedal arm 12 is stopped. Therefore, the rubber member 16 will not be deformed any further. Therefore, the possibility of damage such as cutting or breaking the rubber member 16 is reduced.

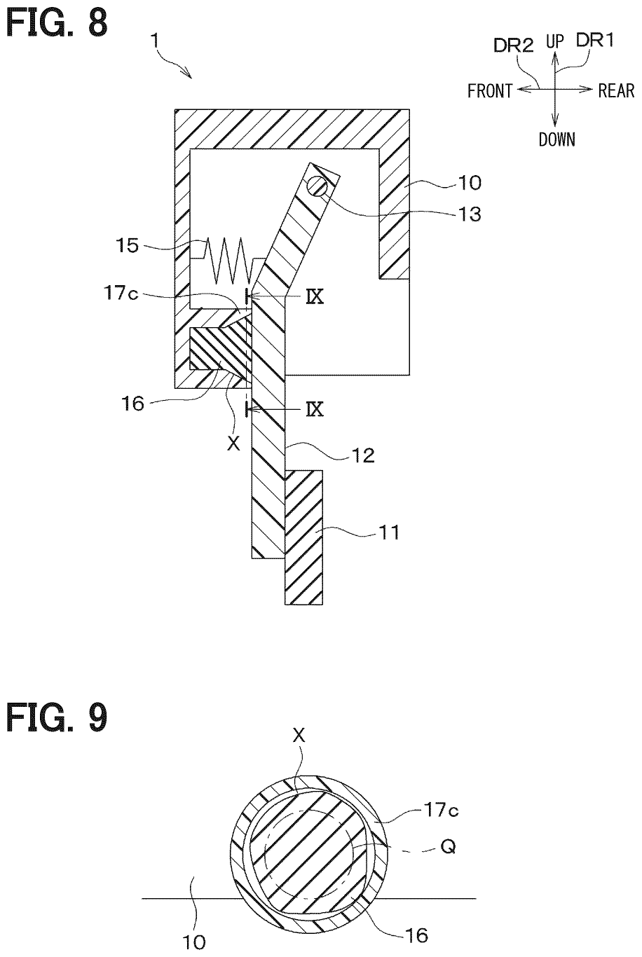

At this time, as shown in FIGS. 8 and 9, there is a space where the rubber member 16 escapes, and the rubber member 16 actually moves thereinto. In such manner, the possibility of causing damage to the rubber member 16 can be reduced. To explain in more detail, an area occupied by the rubber member 16 when the pedal unit is in the initial position as shown in FIG. 7 is defined as an initial rubber area. A circular one-dot chain line Q in FIG. 9 indicates that an inside thereof is the initial rubber area. Further, the position where the pedal unit is restricted by the restricting member 17c as shown in FIG. 8 is defined as a restricted position. A one-dot chain line P in FIG. 7 indicates a position of a surface of the pedal arm 12 on a rubber member 16 side when the pedal unit is in the restricted position.

Further, an overlapped area where a trace area (movable area) of the pedal unit when the pedal unit moves from the initial position to the restricted position overlaps the initial rubber area is defined as an interference area H. In FIG. 7, the initial rubber area on the right side of the one-dot chain line P is an interference area H.

Then, a gap obtained by excluding an area occupied by the pedal unit at the restricted position from a surrounding gap around the initial rubber area is defined as an escape area X. In the present embodiment, as shown in FIGS. 7 to 9, the escape area X surrounded by the restricting member 17c is a space closed by the restricting member 17c, the pedal arm 12, and the rubber member 16.

However, the volume of the escape area X is larger than the volume of the interference area H. Therefore, since there is sufficient space for the rubber member 16 to deform and escape when it is strongly pressed by the pedal arm 12, the possibility of causing damage to the rubber member 16 can be reduced.

As explained above, when the pedal unit is in the restricted position, the escape area X becomes a closed space. Even in such case, when the volume of the escape area X is larger than the volume of the interference area H as described above, the possibility of causing damage to the rubber member 16 can be reduced. In the present embodiment, similar effects can be obtained from the same configuration as in the first embodiment.

### Third Embodiment

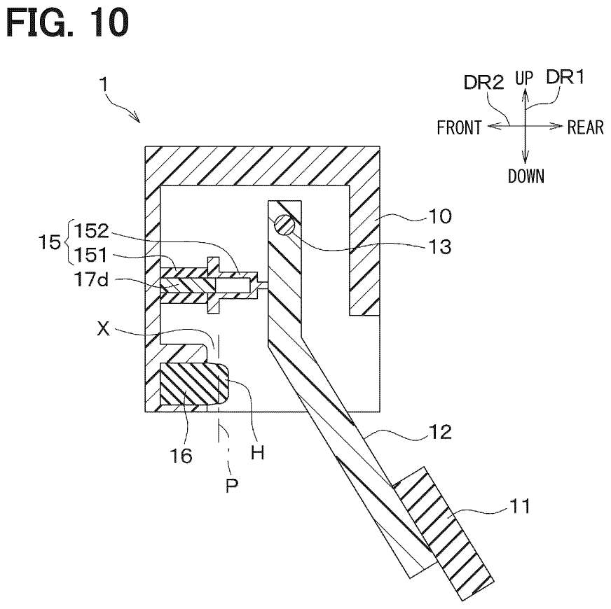

Next, the third embodiment will be described using FIGS. 10 to 12. The present embodiment differs from the first embodiment in the configuration of the reaction force generating mechanism 15, and further, the restricting members 17a and 17b are replaced with a restricting member 17d. The other configuration is the same as that of the first embodiment.

A reaction force generating mechanism 15 of the present embodiment includes an elastic member 151 and a rod 152. The elastic member 151 is a member such as a coil spring or a plate spring that generates a reaction force when compressed. One end of the elastic member is attached to a housing 10 and other end is attached to the rod 152.

The rod 152 has a higher Young's modulus than a rubber member 16. For example, the rod 152 may be made of resin or metal. The rod 152 is a member that transmits a force of the pedal operation received by a pedal pad 11 to the elastic member 151 and also transmits the reaction force of the elastic member 151 to a pedal arm 12. One end of the rod 152 is connected to the elastic member 151, and other end is connected to the pedal arm 12. Further, the rod 152 has a bottomed cylindrical shape in which a hole is formed to receive the restricting member 17d.

The restricting member 17d is a rod-shaped member, and one end thereof is fixed to the housing 10, and is inserted into the hole of the rod 152 with other end as a leading end. The restricting member 17d has a higher Young's modulus than the rubber member 16. For example, the restricting member 17d may be made of resin or metal. In a state in which the restricting member 17d inserted into the hole of the rod 152, the rod 152 is displaceable in a longitudinal direction of the restricting member 17d using the restricting member 17d as a guide. In such manner, the restricting member 17d and the rod 152 have a piston-cylinder relationship.

Similarly to the first embodiment, the reaction force generating mechanism 15 may bias the pedal arm 12 in a returning direction either of (a) when the pedal pad 11 is receiving a pedal operation or (b) when the pedal arm 12 is at the initial position without receiving the pedal operation. Further, the reaction force generating mechanism 15 may be connected to the housing 10 and the pedal arm 12 either of when (a) the pedal pad 11 is receiving the pedal operation or (b) when the pedal pad 11 is at the initial position without receiving the pedal operation.

Hereinafter, the operation of the pedal device 1 having such a configuration will be explained. The contents of the operation in which a signal corresponding to the rotation of a rotating shaft 13 caused by the pedal operation is output and the brake actuator is controlled based on the signal are the same as in the first embodiment.

When a pedal operation is performed on the pedal device 1, the reaction force generating mechanism 15 expands and contracts. Specifically, when there is a depressing operation, the pedal arm 12 presses the rod 152, and the rod 152 presses the elastic member 151. In such manner, the elastic member 151 contracts and generates a stronger reaction force, which is transmitted to the pedal arm 12 via the rod 152.

When a long stroke depressing operation is performed on the pedal pad 11, the pedal arm 12 comes into contact with the rubber member 16 while the pedal unit is displaced in a depressing direction by receiving the reaction force of the reaction force generating mechanism 15. When the pedal arm 12 comes into contact with the rubber member 16, the rubber member 16 generates an elastic force against the pedal arm 12 in the returning direction. This elastic force, that is, the reaction force, stops the movement of the pedal unit. At this time, when the force received by the pedal pad 11 due to the depressing operation is within a predetermined range, a bottom of the hole of the rod 152 does not come into contact with a tip of the restricting member 17d but is separated therefrom. Therefore, the rod 152 is further displaceable toward an elastic member 151 side.

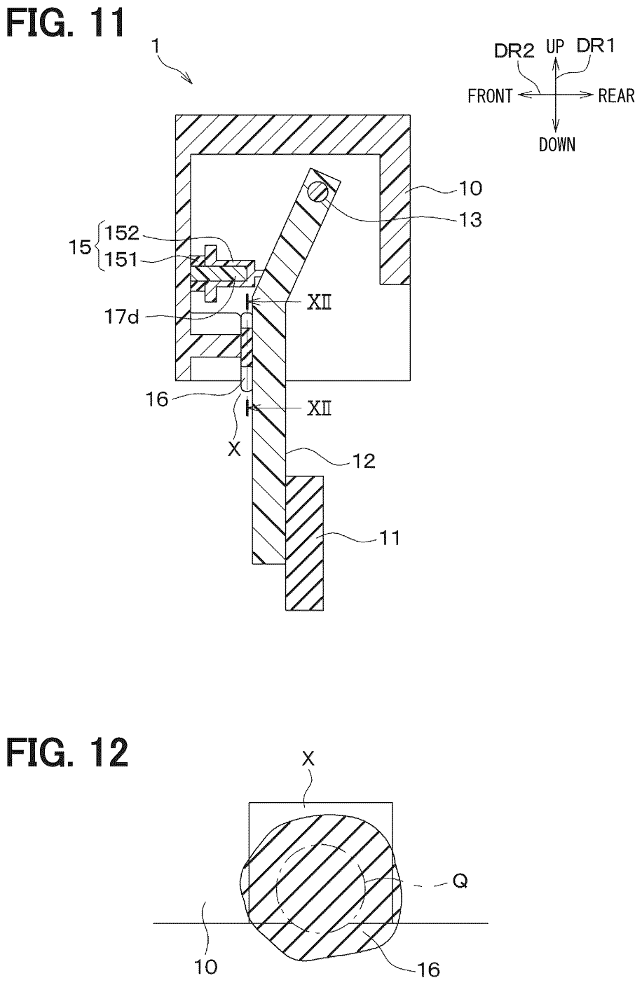

However, when the pedal arm 12 is depressed with a force exceeding the predetermined range, an excessive load is applied from the pedal arm 12 to the rubber member 16 after the pedal arm 12 contacts the rubber member 16. As a result, the rubber member 16 is pressed by the pedal arm 12 and deforms greatly, and the pedal arm 12 moves until the bottom of the hole in the rod 152 comes into contact with the tip of the restricting member 17d, as shown in FIGS. 11 and 12.

When the bottom of the hole of the rod 152 comes into contact with the tip of the restricting member 17d, the movement of the pedal arm 12 is restricted by the restricting member 17d and stops. Therefore, the rubber member 16 will not be deformed any further. Therefore, the possibility of damage such as cutting or breaking the rubber member 16 is reduced. At this time, since the volume of an escape area X is larger than the volume of an interference area H, there is a sufficient escape area for the rubber member 16 to be deformed, which is the same as in the first embodiment.

In such manner, the restricting member 17d may come into contact with the reaction force generating mechanism 15 at a position away from the rubber member 16. The changes made in the present embodiment with respect to the first embodiment may also be applicable to the second embodiment. Further, in the present embodiment, similar effects are obtainable from the same configuration as in the first and second embodiments.

### Fourth Embodiment

Next, the fourth embodiment will be described using FIG. 13. The present embodiment differs from the first embodiment in the manner in which restricting members 17a and 17b are attached. Specifically, as shown in FIG. 13, restricting members 17a and 17b are formed separately from a housing 10, unlike the first embodiment. For example, the restricting members 17a and 17b may be formed separately from the housing 10 and then fixed to the housing 10 by press-fitting, adhesion, welding, or the like.

In such manner, the restricting members 17a and 17b of the present embodiment are formed as separate members from the housing 10 and are fixed to the housing 10. With such a configuration, it is possible to reduce a load transmission path from the pedal unit that receives the pedaling force to a fixing point to the vehicle via the restricting members 17a and 17b that restrict the pedal stroke. As a result, the number of parts that need to be strengthened to withstand strong pedaling can be reduced.

Further, it is easy to replace only the restricting members 17a and 17b while leaving other parts as they are. Therefore, by replacing the restricting members 17a and 17b with ones having different heights, a stroke range of the pedal unit is easily adjustable.

For example, the changes made in the present embodiment with respect to the first embodiment may also be applicable to the second and third embodiments. Further, in the present embodiment, similar effects are obtainable from the same configuration as in the first to third embodiments.

### Fifth Embodiment

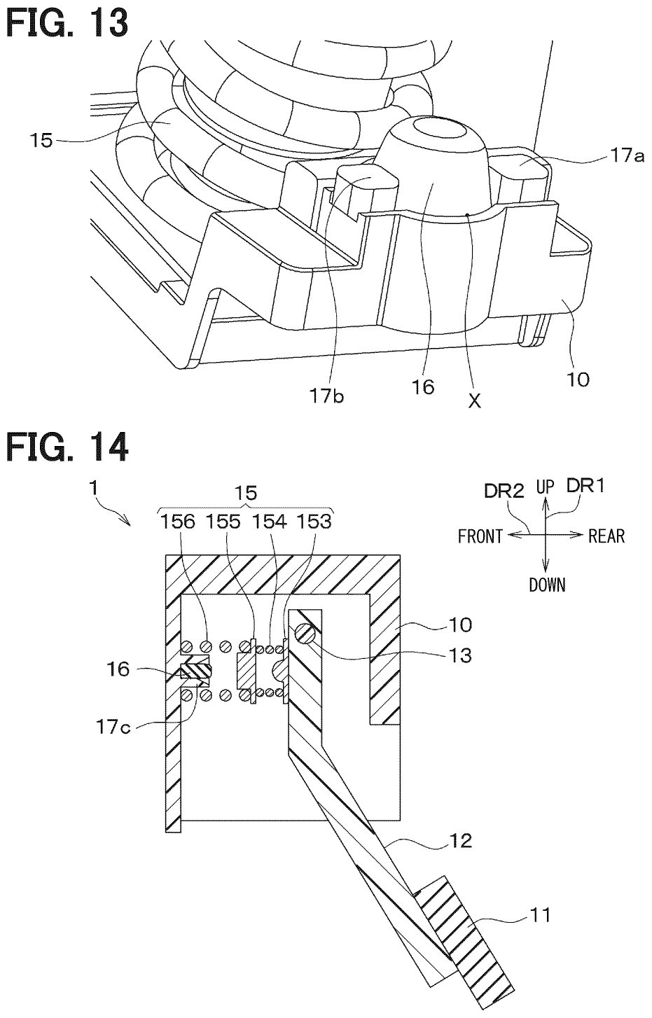

Next, the fifth embodiment will be described using FIG. 14. In the present embodiment, the configuration of a reaction force generating mechanism 15 is changed from the second embodiment, and the positions of a rubber member 16 and a restricting member 17c are changed. The other configurations are the same as the second embodiment.

As shown in FIG. 14, the reaction force generating mechanism 15 of the present embodiment includes a first holder 153, a first spring 154, a second holder 155, and a second spring 156. The first holder 153 is a member that is fixed to a surface of a pedal arm 12 on a bottom wall side of a housing 10, and has a protrusion that protrudes in a direction away from the surface. In the present disclosure, the bottom wall of the housing 10 is a wall on one side of the housing 10 to which the reaction force generating mechanism 15 is attached.

The first spring 154 is, for example, a coil spring, and is arranged at a position between the first holder 153 and the second holder 155 to expand and contract, and has one end in contact with the first holder 153 and other end in contact with the second holder 155. The first spring 154 extends in the vicinity of the first holder 153 to surround the protrusion of the first holder 153.

The second holder 155 is disposed at a position between the first holder 153 and the bottom wall of the housing 10, contacts the other end of the first spring 154 with a surface facing the first holder 153, and contacts one end of the second spring 156 with a surface on a bottom wall side of the housing 10.

The second spring 156 is, for example, a coil spring, and is disposed at a position between the second holder 155 and the bottom wall of the housing 10 to expand and contract, and has one end in contact with the second holder 155 and other end in contact with the bottom wall of the housing 10.

The rubber member 16 and the restricting member 17c of the present embodiment are arranged at a position between the bottom wall described above and the second holder 155. An interference area H and an escape area X similar to those in the second embodiment are arranged opposite to the second holder 155. Note that symbols indicating the interference area H and the escape area X are omitted in FIG. 14. The restricting member 17c may be formed separately from the housing 10 and fixed to the bottom wall of the housing 10, or may be formed integrally with the bottom wall. The relative positional relationship between the rubber member 16 and the restricting member 17c is the same as in the second embodiment.

Hereinafter, the operation of a pedal device 1 having such a configuration will be explained. When a pedal pad 11 is depressed by the driver, the first holder 153 rotates about a rotating shaft 13 together with the pedal pad 11 and the pedal arm 12. In such manner, the first holder 153 approaches the second holder 155, and the first spring 154 is compressed.

When the pedal pad 11 is further depressed, the protrusion of the first holder 153 comes into contact with the second holder 155. As the pedal pad 11 is further depressed, the first holder 153, the first spring 154, and the second holder 155 move toward the rubber member 16 while the protrusion of the first holder 153 remains in contact with the second holder 155. In such manner, the first holder 153, the first spring 154, and the second holder 155 approach the rubber member 16 and the restricting member 17c, and the second spring 156 is compressed.

When the pedal pad 11 is further depressed, the second holder 155 comes into contact with one end of the rubber member 16 on the second holder 155 side. After contacting, an excessive load is applied from the pedal pad 11 to the rubber member 16 via the pedal arm 12, the first holder 153, and the second holder 155. In such manner, the rubber member 16 is pressed by the second holder 155 and deforms greatly, generating a reaction force. At this time, the rubber member 16 is pressed indirectly by the pedal arm 12 via the first holder 153 and the second holder 155.

In the first to third embodiments, the pedal arm 12 directly presses the rubber member 16, whereas in the present embodiment, the pedal arm 12 presses the rubber member 16 indirectly, as described above. However, in either case, the point that the pedal arm 12 is pressing the rubber member 16 is the same.

As the pedal pad 11 is further depressed, the second holder 155 moves until it comes into contact with the restricting member 17c. When the second holder 155 comes into contact with the restricting member 17c, the movements of the second holder 155, first holder 153, and pedal arm 12 are stopped. Therefore, the rubber member 16 will not be deformed any further. Therefore, the possibility of damage such as cutting or breaking the rubber member 16 is reduced. In such manner, when the rubber member 16 is generating a reaction force, the restricting member 17c restricts the displacement of the pedal arm 12.

At this time, there is an escape area X from which the rubber member 16 escapes, and since the volume of the escape area X is larger than the volume of the interference area H, the rubber member 16 actually moves thereinto. In such manner, the possibility of causing damage to the rubber member 16 can be reduced.

As explained above, the rubber member 16 is indirectly connected to the pedal unit displaced by the pedal operation via other parts (i.e., the first holder 153, the first spring 154, and the second holder 155), and generates a reaction force against the displacement of the pedal unit. In such manner, even when the rubber member 16 is pressed indirectly from the pedal unit, the same effect as when it is pressed directly is obtainable.

Further, in the present embodiment, the same effects are obtainable from the same configurations as the second embodiment. In addition, the restricting member 17c of the present embodiment may be replaced with the shape as shown in the restricting members 17a and 17b of the first embodiment. Further, the first spring 154 and the second spring 156 may be replaced with elastic members other than springs.

### Sixth Embodiment

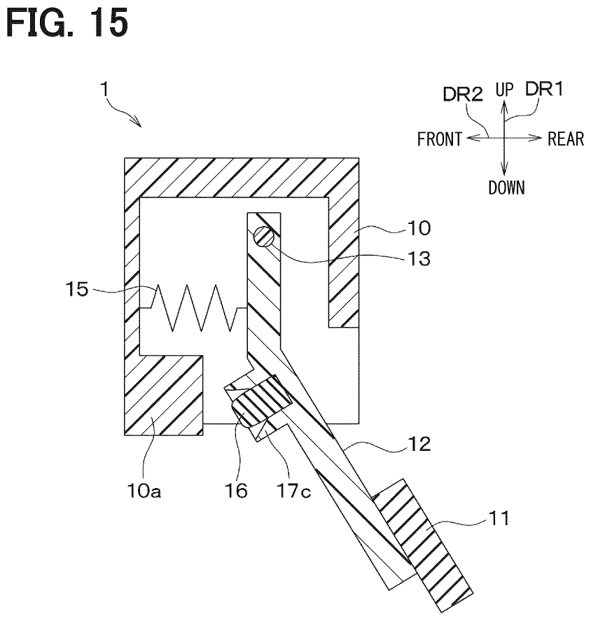

Next, the sixth embodiment will be described using FIG. 15. In the present embodiment, the positions of a rubber member 16 and a restricting member 17c are changed from those in the second embodiment, and the shape of a housing 10 is partially changed. The other configurations are the same as the second embodiment.

The rubber member 16 and the restricting member 17c of the present embodiment are arranged on a bottom wall side of the housing 10 in a pedal arm 12. An interference area H and an escape area X, similar to those in the second embodiment, are arranged opposite to the bottom wall of the housing 10. Note that symbols indicating the interference area H and the escape area X are omitted in FIG. 15. The restricting member 17c may be formed separately from the pedal arm 12 and fixed to the pedal arm 12, or may be formed integrally with the pedal arm 12. The relative positional relationship between the rubber member 16 and the restricting member 17c is the same as in the second embodiment. Further, a portion of the bottom wall of the housing 10 that faces the rubber member 16 is a protruding portion 10a that protrudes toward a rubber member 16 side.

Hereinafter, the operation of the pedal device 1 having the above-described configuration will be explained. When the pedal pad 11 is depressed by the driver, the pedal pad 11, the pedal arm 12, the rubber member 16, and the restricting member 17c forming one body rotate about the rotating shaft 13 to approach the protruding portion 10a. When the force that the pedal pad 11 receives from the driver is within a predetermined range, the restricting member 17c does not come into contact with the protruding portion 10a.

When the pedal pad 11 is depressed with a force exceeding the predetermined range, the rubber member 16 comes into contact with the protruding portion 10a, and an excessive load is applied to the rubber member 16 from the protruding portion 10a and the pedal arm 12. In such manner, the rubber member 16 is pressed by the pedal arm 12 and the protruding portion 10a, deforms greatly and generates a reaction force, and further moves together with the pedal arm 12 until the restricting member 17c comes into contact with the protruding portion 10a.

When the restricting member 17c comes into contact with the protruding portion 10a, the movement of the pedal arm 12 is stopped. Therefore, the rubber member 16 will not be deformed any further. Therefore, the possibility of damage such as cutting or breaking the rubber member 16 is reduced.

At this time, there is the escape area X from which the rubber member 16 escapes, and since the volume of the escape area X is larger than the volume of the interference area H, the rubber member 16 actually moves thereinto. In such manner, the possibility of causing damage to the rubber member 16 can be reduced.

As described above, the rubber member 16 and the restricting member 17c of the present embodiment move integrally with the pedal arm 12, but are distinguished from the pedal unit as configuration elements. In the present embodiment, the same effects are obtainable from same configurations as the second embodiment. Further, the restricting member 17c of the present embodiment may be replaced with the shape shown by the restricting members 17a and 17b of the first embodiment.

### Other Embodiments

The present disclosure is not limited to the above-described embodiments, and can be appropriately modified. Each of the above embodiments, which are relevant to each other, is combinable to the other one unless such combination is clearly difficult. The configuration element(s) of each of the above embodiments is/are not necessarily essential unless it is specifically stated that the configuration element(s) is/are essential in the above embodiments, or unless the configuration element(s) is/are obviously essential in principle. A quantity, a value, an amount, a range, or the like of the configuration element referred to in the description of the above embodiments is not necessarily limited to the described specific value, amount, range or the like unless it is specifically described as essential or understood as being essential in principle. When multiple values are exemplified for a certain parameter, it is also possible to adopt a value between the multiple values unless an exception statement is made or when it is clearly impossible in principle. Further, a shape, positional relationship or the like of a configuration element, which is referred to in the embodiments described above, is not limited to the described shape, positional relationship or the like, unless it is specifically described or obviously necessary to be limited in principle. Further, the present disclosure allows the following modifications and equivalent modifications to each of the above embodiments. The following modifications can be independently selected to be applied or not applied to the above-described embodiments. That is, any combination of the modified examples described below can be applied to the above embodiments.

### (Modifications)

In the above embodiments, a pendant-type pedal device 1 is disclosed, but the pedal device 1 may be of a type other than a pendant type (for example, an organ type). Further, in the above embodiments, the pedal device 1 has the sensor 20 and the reaction force generating mechanism 15 for realizing brake-by-wire, but it may be used in a hydraulic brake system without having these. Further, in the above embodiments, the pedal device 1 is a brake pedal, but it may also be an accelerator pedal.

### (Various Viewpoints)

### [Viewpoint 1]

A pedal device for a vehicle includes:
a pedal unit (11, 12, 13) configured to be displaced in response to a pedal operation from a driver of the vehicle;
a rubber member (16) configured to be pressed by the pedal unit displaced in response to the pedal operation and to generate a reaction force against a displacement of the pedal unit; and a restricting member (17a to 17d) configured to restrict the displacement of the pedal unit separately from the rubber member, when the rubber member generates the reaction force.

### [Viewpoint 2]

In the pedal device of viewpoint 1, (i) when an area occupied by the rubber member in a state where the pedal unit is in an initial position without receiving the pedal operation is defined as an initial rubber area, and (ii) when an overlapped area in which a trace area of the pedal unit when the pedal unit moves from the initial position to a restricted position where the pedal unit is restricted overlaps with the initial rubber area is defined as an interference area (H), a volume of an escape area (X) which is a space obtained by excluding an area occupied by the pedal unit at the restricted position from a surrounding space around the initial rubber area is greater than a volume of the interference area (H).

### [Viewpoint 3]

In the pedal device of viewpoint 2, when the pedal unit is in the restricted position, the escape area is a space open to an outside of the pedal device.

### [Viewpoint 4]

In the pedal device of viewpoint 2, when the pedal unit is in the restricted position, the escape area is a closed space.

### [Viewpoint 5]

In the pedal device of any one of viewpoints 1 to 4, the restricting member is made of resin or metal.

### [Viewpoint 6]

In the pedal device of any one of viewpoints 1 to 5, the restricting member restricts the displacement of the pedal unit by coming into contact with a component that presses the rubber member among one or more components constituting the pedal unit.

### [Viewpoint 7]

In the pedal device according to any one of viewpoints 1 to 6, the restricting member comes into contact with the pedal unit to restrict the displacement of the pedal unit.

### [Viewpoint 8]

The pedal device according to any one of viewpoints 1 to 7 further includes a housing (10) that holds the pedal unit, the rubber member, and the restricting member and is fixed to the vehicle, and the restricting member is formed separately from the housing, and is fixed to the housing.

### [Viewpoint 9]

The pedal device according to any one of viewpoints 1 to 7 further includes a housing (10) that holds the pedal unit, the rubber member, and the restricting member, and is fixed to the vehicle. In addition, the restricting member is integrally formed with the housing.

### [Viewpoint 10]

In the pedal device according to any one of viewpoints 1 to 9, the rubber member is configured to be indirectly pressed via an another part (153, 154, 155) by the pedal unit that is displaced in response to the pedal operation, and to generate a reaction force against the displacement of the pedal unit.

What is claimed is:

1. A pedal device for a vehicle, comprising:
a pedal unit configured to be displaced in response to a pedal operation from a driver of the vehicle;
a rubber member configured to be pressed by the pedal unit displaced in response to the pedal operation and to generate a reaction force against a displacement of the pedal unit; and
a restricting member configured to restrict the displacement of the pedal unit separately from the rubber member, when the rubber member generates the reaction force.

2. The pedal device according to claim 1, wherein
(i) when an area occupied by the rubber member in a state where the pedal unit is in an initial position without receiving the pedal operation is defined as an initial rubber area, and (ii) when an overlapped area in which a trace area of the pedal unit when the pedal unit moves from the initial position to a restricted position where the pedal unit is restricted overlaps with the initial rubber area is defined as an interference area, a volume of an escape area which is a space obtained by excluding an area occupied by the pedal unit at the restricted position from a surrounding space around the initial rubber area is greater than a volume of the interference area.

3. The pedal device according to claim 2, wherein
when the pedal unit is in the restricted position, the escape area is a space open to an outside of the pedal device.

4. The pedal device according to claim 2, wherein
when the pedal unit is in the restricted position, the escape area is a closed space.

5. The pedal device according to claim 1, wherein
the restricting member is made of resin or metal.

6. The pedal device according to claim 1, wherein
the restricting member restricts the displacement of the pedal unit by coming into contact with a component that presses the rubber member among one or more components constituting the pedal unit.

7. The pedal device according to claim 1, wherein
the restricting member comes into contact with the pedal unit to restrict the displacement of the pedal unit.

8. The pedal device according to claim 1, further comprising:
a housing fixed to the vehicle to hold the pedal unit, the rubber member and the restricting member, wherein
the restricting member is formed separately from the housing, and is fixed to the housing.

9. The pedal device according to claim 1, further comprising:
a housing fixed to the vehicle to hold the pedal unit, the rubber member, and the restricting member, wherein
the restricting member is integrally formed with the housing.

10. The pedal device according to claim 1, wherein
the rubber member is configured to be indirectly pressed via an another part by the pedal unit that is displaced in response to the pedal operation, and to generate a reaction force against the displacement of the pedal unit.

11. The pedal device according to claim 1, further comprising
a reaction force generating mechanism that is different from the rubber member and configured to generate a reaction force against the displacement of the pedal unit when the pedal unit is displaced by the pedal operation.

12. The pedal device according to claim 11, wherein
when the pedal operation is performed to the pedal unit, the rubber member starts to generate the elastic force to the pedal unit in a direction opposite to the displacement of the pedal unit during the displacement of the pedal unit in response to the reaction force of the reaction force generating mechanism.
